(19) United States
(12) Patent Application Publication
(10) Pub. No.: US 2014/0334350 A1
(43) Pub. Date: Nov. 13, 2014

(54) METHODS AND APPARATUS FOR CELL MEASUREMENT

(71) Applicant: RESEARCH IN MOTION LIMITED, Waterloo (CA)

(72) Inventors: Takashi SUZUKI, Ichikawa (JP); Andrew John FARNSWORTH, Kidderminster (GB); Tomasz Henryk MACH, Fleet (GB); Rene Waraputra PURNADI, Irving, TX (US); Andrew John Ellington, Cambridge (GB)

(73) Assignee: RESEARCH IN MOTION LIMITED, WATERLOO (CA)

(21) Appl. No.: 13/890,057

(22) Filed: May 8, 2013

(51) Int. Cl. H04W 24/02

(52) U.S. Cl. CPC H04W 24/02
USPC 370/280

(57) ABSTRACT

Methods and apparatus for cell measurement. An example method in a network device includes receiving configuration information including at least one of multimedia broadcast single frequency network (MBSFN) configuration or time division duplex (TDD) configuration for an evolved universal terrestrial radio access network (E-UTRAN) and transmitting the configuration information to a user equipment, wherein the network device is associated with a radio access technology different from E-UTRAN.

### BACKGROUND

Acronym Full Text
1xRTT One times Radio Transmission Technology
CDMA Code Division Multiple Access
CRS Cell specific Reference Signal
E-UTRAN Evolved UTRAN
FDD Frequency Division Duplex
GERAN GSM EDGE Radio Access Network
HRPD High Rate Packet Data
IE Information Element
MCH Multicast Channel
MCCH Multicast Control Channel
MBMS Multimedia Broadcast Multicast Service
MBSFN Multimedia Broadcast Single Frequency Network
OAM Operations Administration and Maintenance
RAT Radio Access Technology
RRM Radio Resource Management
SFN System Frame Number
TDD Time Division Duplex
UTRAN Universal Terrestrial Radio Access Network

Multimedia Broadcast Multicast Services (MBMS) is a point to multipoint interface that may be utilized to distribute multimedia services (e.g., television content) alongside traditional voice and data services in a cellular network. Single Frequency Network (SFN) is utilized in E-UTRAN to support MBMS. Multiple base stations are involved in Multimedia Broadcast Single Frequency Network (MBSFN) transmission in specific MBSFN subframes.

An MBSFN subframe includes a unicast part and an MBSFN part for which MCH is utilized. An example MBSFN subframe has cell specific reference signal (CRS) in the first one or two symbols and MBSFN reference signals (R4) in the rest of the subframe as shown in the FIG. 2 below. Due to synchronization signals, Physical Broadcast Channel (PBCH) and paging, certain subframes in a radio frame are not allowed to carry MBSFN or MCH transmissions and are called non-MBSFN subframes. For example, subframe #0, #4, #5 and #9 are non-MBSFN subframes in FDD and subframe #0, #1, #2, #6 and #7 are non-MBSFN subframes in TDD.

### BRIEF DESCRIPTION OF DRAWINGS

FIG. 1 shows a block diagram of an example implementation of a mobile device.

FIG. 2 illustrates an example subframe allocated for MBSFN.

FIG. 3 illustrates non-MBSFN subframes for a two antenna port example.

FIG. 4 is a block diagram of an example implementation of the network.

FIG. 5 is a flowchart of example instructions performed by the GERAN and/or the UTRAN.

FIG. 6 is a flowchart of example instructions performed by the configuration information handler of the mobile device while the mobile device is camped on or connected to the GERAN or the UTRAN.

FIG. 7 is a flowchart of example instructions performed by the configuration information handler of the mobile device while the mobile device is camped on the GERAN and/or the UTRAN.

FIG. 8 is a flowchart of example instructions performed by the GERAN and/or the UTRAN.

### DETAILED DESCRIPTION

In E-UTRAN, a UE is provided with information about MBSFN subframe allocation of the serving cell and an indication of whether the allocation is applicable to neighboring cells. The UE utilizes the information to locate symbols carrying CRS for RRM measurement of neighbor cells in a E-UTRAN frequency to measure. For example, 4 symbols in non-MBSFN subframes and 1 symbol in the subframes configured as an MBSFN subframe. However, when a UE is camped on another radio access technology such as GERAN or UTRAN, System Information and measurement configuration do not indicate whether E-UTRA frequencies may have MBSFN configured. As a result when measurements of E-UTRA cells are taken from those RATs, the UE assumes that MBSFN may be configured in all subframes except the known non-MBSFN subframes. Because some of the assumed to be possibly MBSFN subframes, that carry fewer symbols carrying CRS may actually not be allocated for MBSFN, they are actually available for RRM measurement. For example, if an elapsed measurement duration is kept constant, the measurement accuracy is degraded because fewer symbols carrying CRS are used. Alternatively, if the measurement time is increased to maintain accuracy, power consumption by the UE increases.

Similarly, a configuration of an E-UTRA neighbor TDD cell (e.g., special subframe patterns and uplink and downlink configuration) is also not reported to a UE when camped in GERAN and UTRAN. The UE assumes the worst case when E-UTRA TDD cells are measured from the other RATs, which results in similar disadvantages to the MBSFN configuration.

Example methods and apparatus described herein facilitate apprising a UE of configuration information (e.g., MBSFN configuration, TDD configuration, etc.) for E-UTRA neighbor cells while camped on a RAT different than E-UTRA (e.g., GERAN, UTRAN, etc.). When the UE is informed of such configuration information, the UE can efficiently communicate with the network by using available resources (e.g., without mistakenly assuming that resources are assigned in a particular manner). For example, in UTRAN Idle mode, the measurement of neighbor cells can contribute a significant proportion of the average current draw from the battery. Reducing the time to measure an E-UTRAN cell by allowing UE to make use of all the available symbols carrying CRS of that cell may result in significant battery saving, more accurate measurements, or both.

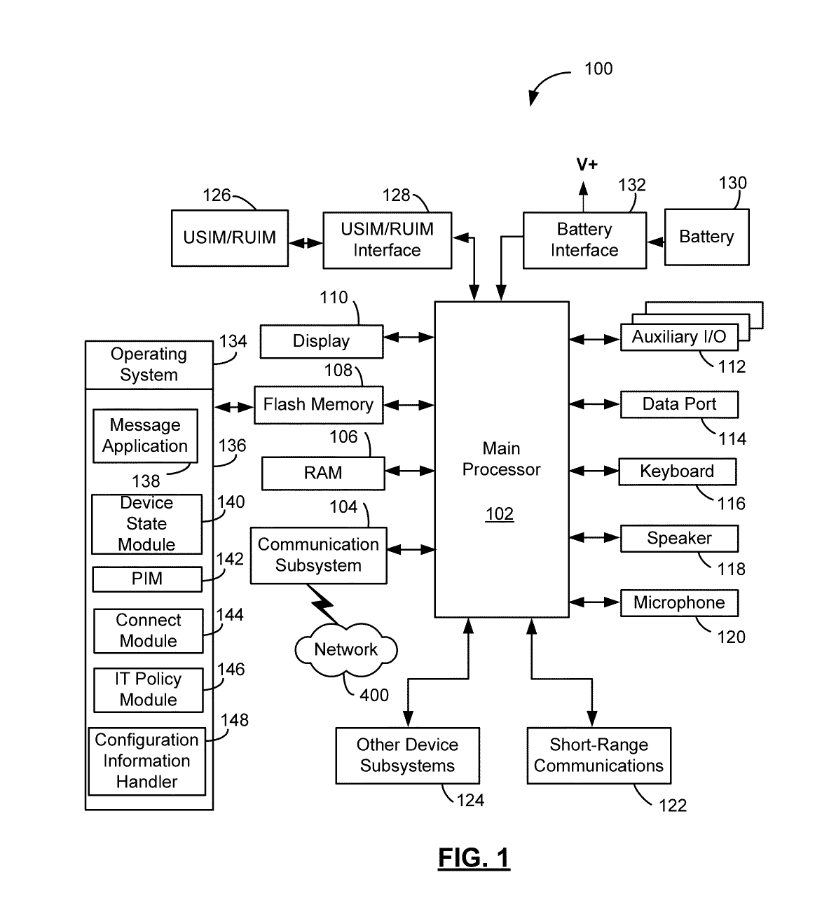

Referring first to FIG. 1, shown therein is a block diagram of an example implementation of a mobile device (e.g., user equipment, wireless terminal, cellular device, etc.) 100. The mobile device 100 includes a number of components such as a main processor 102 that controls the overall operation of the mobile device 100. Communication functions, including data and voice communications, are performed through a communication subsystem 104. The communication subsystem 104 receives messages from and sends messages to a wireless network 400. In this example implementation of the mobile device 100, the communication subsystem 104 is configured in accordance with the E-UTRA and at least one of GERA and UTRA. Alternatively, any other type of network service may additionally or alternatively be utilized CDMA 2000 1xRTT and HRPD and 801.11 Wireless LAN. New standards are still being defined, but it is believed that they will have similarities to the network behavior described herein, and it will also be understood by persons skilled in the art that the implementations described herein are intended to use any other suitable standards that are developed in the future. The wireless link connecting the communication subsystem 104 with the wireless network represents one or more different Radio Frequency (RF) channels, operating according to defined protocols specified for UMTS communications. These channels may support both circuit switched communications and packet switched communications.

The main processor 102 also interacts with additional subsystems such as a Random Access Memory (RAM) 106, a flash memory 108, a display 110, an auxiliary input/output (I/O) subsystem 112, a data port 114, a keyboard 116, a speaker 118, a microphone 120, short-range communications 122 and other device subsystems 124.

Some of the subsystems of the mobile device 100 perform communication-related functions, whereas other subsystems may provide “resident” or on-device functions. By way of example, the display 110 and the keyboard 116 may be used for both communication-related functions, such as entering a text message for transmission over the network 200, and device-resident functions such as a calculator or task list.

The mobile device 100 can send and receive communication signals over the wireless network 400 after required network registration or activation procedures have been completed. Network access is associated with a subscriber or user of the mobile device 100. To identify a subscriber, the mobile device 100 requires a USIM/RUIM card 126 (i.e. Universal Subscriber Identity Module or a Removable User Identity Module) to be inserted into a USIM/RUIM interface 128 in order to communicate with the network 400. The USIM card or RUIM 126 is one type of a conventional “smart card” that can be used to identify a subscriber of the mobile device 100 and to personalize the mobile device 100, among other things. Without the USIM card 126, the mobile device 100 is not fully operational for communication with the network 400. By inserting the USIM card/RUIM 126 into the USIM/RUIM interface 128, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The USIM card/RUIM 126 includes a processor and memory for storing information. Once the USIM card/RUIM 126 is inserted into the USIM/RUIM interface 128, it is coupled to the main processor 102. In order to identify the subscriber, the USIM card/RUIM 126 can include some user parameters such as an International Mobile Subscriber Identity (IMSI). An advantage of using the USIM card/RUIM 126 is that a subscriber is not necessarily bound by any single physical mobile device. The USIM card/RUIM 126 may store additional subscriber information for a mobile device as well, including datebook (or calendar) information and recent call information. Alternatively, user identification information can also be programmed into the flash memory 108.

The mobile device 100 is typically a battery-powered device and includes a battery interface 132 for receiving one or more rechargeable batteries 130. In at least some implementations, the battery 130 can be a smart battery with an embedded microprocessor. The battery interface 132 is coupled to a regulator (not shown), which assists the battery 130 in providing power V+ to the mobile device 100. Although current technology makes use of a battery, future technologies such as micro fuel cells may provide the power to the mobile device 100.

The mobile device 100 also includes an operating system 134 and software components 136 to 148 which are described in more detail below. The operating system 134 and the software components 136 to 148 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 148, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, will normally be installed on the mobile device 100 during its manufacture. Other software applications include a message application 138 that can be any suitable software program that allows a user of the mobile device 100 to send and receive electronic messages. Various alternatives exist for the message application 138 as is well known to those skilled in the art. Messages that have been sent or received by the user are typically stored in the flash memory 108 of the mobile device 100 or some other suitable storage element in the mobile device 100. In at least some implementations, some of the sent and received messages may be stored remotely from the device 100 such as in a data store of an associated host system that the mobile device 100 communicates with.

The software applications can further include a device state module 140, a Personal Information Manager (PIM) 142, and other suitable modules (not shown). The device state module 140 provides persistence, i.e. the device state module 140 ensures that important device data is stored in persistent memory, such as the flash memory 108, so that the data is not lost when the mobile device 100 is turned off or loses power.

The PIM 142 includes functionality for organizing and managing data items of interest to the user, such as, but not limited to, e-mail, contacts, calendar events, voice mails, appointments, and task items. A PIM application has the ability to send and receive data items via the wireless network. PIM data items may be seamlessly integrated, synchronized, and updated via the wireless network with the mobile device subscriber's corresponding data items stored and/or associated with a host computer system. This functionality creates a mirrored host computer on the mobile device 100 with respect to such items. This can be particularly advantageous when the host computer system is the mobile device subscriber's office computer system.

The mobile device 100 also includes a connect module 144, and an IT policy module 146. The connect module 144 implements the communication protocols that are required for the mobile device 100 to communicate with the wireless infrastructure and any host system, such as an enterprise system, that the mobile device 100 is authorized to interface with.

The connect module 144 includes a set of APIs that can be integrated with the mobile device 100 to allow the mobile device 100 to use any number of services associated with the enterprise system. The connect module 144 allows the mobile device 100 to establish an end-to-end secure, authenticated communication pipe with the host system. A subset of applications for which access is provided by the connect module 144 can be used to pass IT policy commands from the host system to the mobile device 100. This can be done in a wireless or wired manner. These instructions can then be passed to the IT policy module 146 to modify the configuration of the device 100. Alternatively, in some cases, the IT policy update can also be done over a wired connection.

The IT policy module 146 receives IT policy data that encodes the IT policy. The IT policy module 146 then ensures that the IT policy data is authenticated by the mobile device 100. The IT policy data can then be stored in the flash memory 108 in its native form. After the IT policy data is stored, a global notification can be sent by the IT policy module 146 to all of the applications residing on the mobile device 100. Applications for which the IT policy may be applicable then respond by reading the IT policy data to look for IT policy rules that are applicable.

The IT policy module 146 can include a parser (not shown), which can be used by the applications to read the IT policy rules. In some cases, another module or application can provide the parser. Grouped IT policy rules, described in more detail below, are retrieved as byte streams, which are then sent (recursively, in a sense) into the parser to determine the values of each IT policy rule defined within the grouped IT policy rule. In at least some implementations, the IT policy module 146 can determine which applications are affected by the IT policy data and send a notification to only those applications. In either of these cases, for applications that aren't running at the time of the notification, the applications can call the parser or the IT policy module 146 when they are executed to determine if there are any relevant IT policy rules in the newly received IT policy data.

After the IT policy rules have been applied to the applicable applications or configuration files, the IT policy module 146 sends an acknowledgement back to the host system to indicate that the IT policy data was received and successfully applied.

The mobile device 100 also includes a configuration information handler 148. As described in conjunction with the remaining figures, the configuration information handler 148 determines configuration information about E-UTRA neighbor frequencies to measure while the mobile device 100 is camped on or connected to a RAT other than E-UTRA (e.g., GERAN or UTRAN). In some examples, the configuration information handler 148 receives the configuration information from the GERAN or UTRAN. In some examples, the configuration information handler 148 reads the information from the E-UTRA and reports the information to the GERAN or UTRAN. In some examples, the configuration information handler 148 stores the read information in a cache for later usage. While a single configuration information handler 148 illustrated, the recovery module may comprise multiple components and/or may be integrated with other components.

Other types of software applications can also be installed on the mobile device 100. These software applications can be third party applications, which are added after the manufacture of the mobile device 100. Examples of third party applications include games, calculators, utilities, etc.

The additional applications can be loaded onto the mobile device 100 through at least one of the wireless network, the auxiliary I/O subsystem 112, the data port 114, the short-range communications subsystem 122, or any other suitable device subsystem 124. This flexibility in application installation increases the functionality of the mobile device 100 and may provide enhanced on-device functions, communication-related functions, or both. For example, secure communication applications may enable electronic commerce functions and other such financial transactions to be performed using the mobile device 100.

The data port 114 enables a subscriber to set preferences through an external device or software application and extends the capabilities of the mobile device 100 by providing for information or software downloads to the mobile device 100 other than through a wireless communication network. The alternate download path may, for example, be used to load an encryption key onto the mobile device 100 through a direct and thus reliable and trusted connection to provide secure device communication.

The data port 114 can be any suitable port that enables data communication between the mobile device 100 and another computing device. The data port 114 can be a serial or a parallel port. In some instances, the data port 114 can be a USB port that includes data lines for data transfer and a supply line that can provide a charging current to charge the battery 130 of the mobile device 100.

The short-range communications subsystem 122 provides for communication between the mobile device 100 and different systems or devices, without the use of the wireless network. For example, the subsystem 122 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 104 and input to the main processor 102. The main processor 102 will then process the received signal for output to the display 110 or alternatively to the auxiliary I/O subsystem 112. A subscriber may also compose data items, such as e-mail messages, for example, using the keyboard 116 in conjunction with the display 110 and possibly the auxiliary I/O subsystem 112. The auxiliary subsystem 112 may include devices such as: a touch screen, mouse, track ball, infrared fingerprint detector, an optical navigation control or trackpad, or a roller wheel with dynamic button pressing capability. The keyboard 116 is preferably an alphanumeric keyboard and/or telephone-type keypad. However, other types of keyboards may also be used. A composed item may be transmitted over the wireless network through the communication subsystem 104.

For voice communications, the overall operation of the mobile device 100 is substantially similar, except that the received signals are output to the speaker 118, and signals for transmission are generated by the microphone 120. Alternative voice or audio I/O subsystems, such as a voice message recording subsystem, can also be implemented on the mobile device 100. Although voice or audio signal output is accomplished primarily through the speaker 118, the display 110 can also be used to provide additional information such as the identity of a calling party, duration of a voice call, or other voice call related information.

While an example manner of implementing the mobile device 100 including the configuration information handler 148 is illustrated in FIG. 1, one or more of the elements, processes and/or devices illustrated in FIG. 1 may be combined, divided, re-arranged, omitted, eliminated and/or implemented in any other way. Further, the illustrated components (including the configuration information 148) of the mobile device 100 may be implemented by hardware, software, firmware and/or any combination of hardware, software and/or firmware. Thus, the components of the mobile device 100 could be implemented by one or more circuit(s), programmable processor(s), application specific integrated circuit(s) (ASIC(s)), programmable logic device(s) (PLD(s)) and/or field programmable logic device(s) (FPLD(s)), etc. When any of the appended apparatus claims are read to cover a purely software and/or firmware implementation, at least one of the components are hereby expressly defined to include a computer readable medium such as a memory, DVD, CD, etc. storing the software and/or firmware.

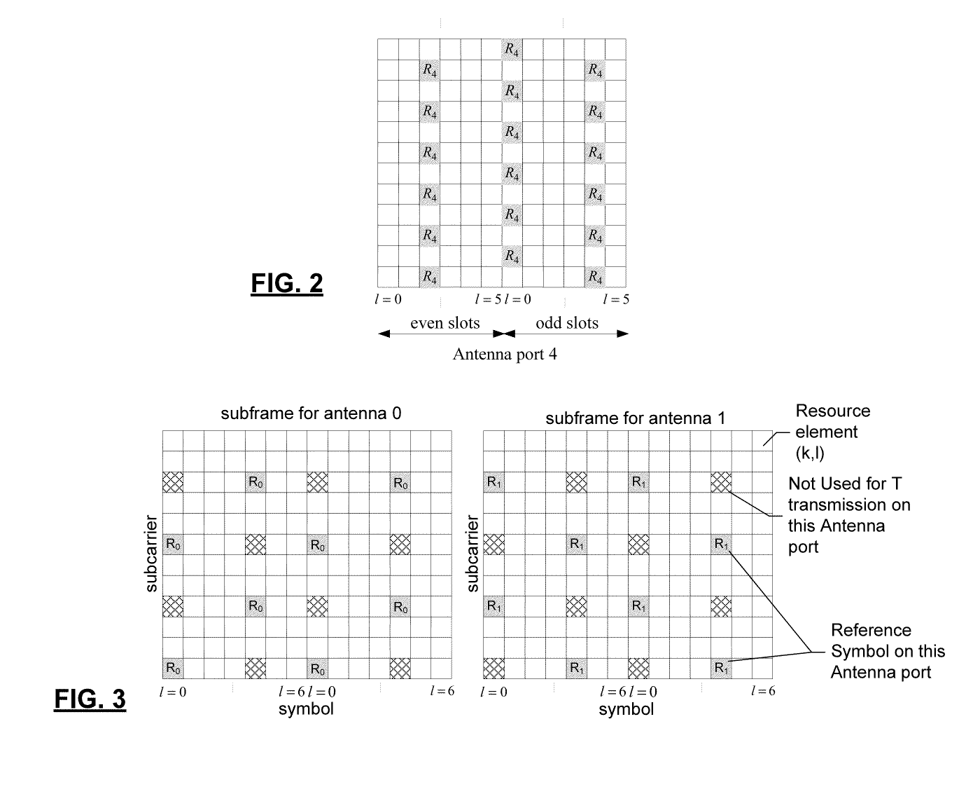

FIG. 2 illustrates an example subframe allocated for MBSFN (e.g., an MBSFN subframe). The MBSFN reference signals are transmitted on antenna port 4 as shown in the example figure. FIG. 3 illustrates non-MBSFN subframes for a two antenna port example. The number of symbols carrying CRS in a non-MBSFN subframe is four compared to one in MBSFN subframes. Accordingly, when a UE assumes that a subframe may contain MBSFN, there are 3 fewer symbols carrying CRS available for measurement. As described herein, the configuration information handler 148 of the mobile device 100 facilitates the UE learning of the configuration of E-UTRA neighbor cells to facilitate efficient communication with the network 400.

In E-UTRA, MBSFN subframe configuration information may be signaled to the mobile device 100 in system information transmitted by the E-UTRAN. For example system information block type 2 (SIB2) may indicate MBSFN-SubframeConfigList. The list may comprise up to 8 configurations of MBSFN subframe allocation as shown below. For example, the list may represent MBSFN subframe allocation up to 32*6 subframes in up to 8 bitmaps.

MBSFN-SubframeConfig

The IE MBSFN-SubframeConfig defines subframes that are reserved for MBSFN in downlink.

MBSFN-SubframeConfig information element

| | |
|---|---|
| -- ASN1START | |
| MBSFN-SubframeConfig ::= | SEQUENCE { |
| radioframeAllocationPeriod | ENUMERATED |
| {n1, n2, n4, n8, n16, n32}, | |
| radioframeAllocationOffset | INTEGER (0..7), |
| subframeAllocation | CHOICE { |
| oneFrame | BIT |
| STRING (SIZE(6)), | |
| fourFrames | BIT |
| STRING (SIZE(24)) | |
| } | |
| } | |
| -- ASN1STOP | |

MBSFN-SubframeConfig field descriptions

fourFrames
A bit-map indicating MBSFN subframe allocation in four consecutive
radio frames, “1” denotes that the corresponding subframe is allocated
for MBSFN. The bitmap is interpreted as follows:
FDD: Starting from the first radioframe and from the first/leftmost bit in
the bitmap, the allocation applies to subframes #1, #2, #3, #6, #7, and #8
in the sequence of the four radio-frames.
TDD: Starting from the first radioframe and from the first/leftmost bit in
the bitmap, the allocation applies to subframes #3, #4, #7, #8, and #9 in
the sequence of the four radio-frames. The last four bits are not used.
Uplink subframes are not allocated.
oneFrame
“1” denotes that the corresponding subframe is allocated for MBSFN.
The following mapping applies:
FDD: The first/leftmost bit defines the MBSFN allocation for subframe
#1, the second bit for #2, third bit for #3, fourth bit for #6, fifth bit for
#7, sixth bit for #8.
TDD: The first/leftmost bit defines the allocation for subframe #3, the
second bit for #4, third bit for #7, fourth bit for #8, fifth bit for #9.
Uplink subframes are not allocated. The last bit is not used.
radioFrameAllocationPeriod, radioFrameAllocationOffset
Radio-frames that contain MBSFN subframes occur when equation SFN
mod radioFrameAllocationPeriod = radioFrameAllocationOffset is
satisfied. Value n1 for radioframeAllocationPeriod denotes value 1, n2
denotes value 2, and so on. When fourFrames is used for
subframeAllocation, the equation defines the first radio frame referred
to in the description below. Values n1 and n2 are not applicable when
fourFrames is used.
subframeAllocation
Defines the subframes that are allocated for MBSFN within the radio
frame allocation period defined by the radioFrameAllocationPeriod and
the radioFrameAllocationOffset.

When the mobile device 100 measures serving and neighbour cells, the UE may utilize the MBSFN allocation information to locate the symbols carrying CRS. For example, in a non-MBSFN subframe, the mobile device 100 may expect CRS from port 0 in symbols 0, 3, 7 and 10, and in an MBSFN subframe, the mobile device 100 may expect CRS from port 0 in the symbol 0 only. If the mobile device 100 does not have the MBSFN allocation information, the mobile device 100 is expected to assume that any subframe that can be an MBSFN may be an MBSFN subframe.

In order to facilitate neighbor cell measurements, system information block type 3 (SIB3) indicates NeighCellConfig (Neighbor Cell Configuration). For example, if it is set to 00, the mobile device 100 needs to assume that all subframes except non-MBSFN subframes may be MBSFN subframes. If it is set to 01, the mobile device 100 may assume that MBSFN subframe allocations are the same (or a subset) as PCell or the serving cell.

NeighCellConfig

The IE NeighCellConfig is used to provide the information related to MBSFN and TDD UL/DL configuration of neighbor cells.

NeighCellConfig Information Element

-- ASN1START
NeighCellConfig ::= BIT STRING (SIZE (2))
-- ASN1STOP

NeighCellConfig field descriptions

neighCellConfig
Provides information related to MBSFN and TDD UL/DL
configuration of neighbour cells of this frequency
00: Not all neighbour cells have the same MBSFN subframe
allocation as the serving cell on this frequency, if configured,
and as the PCell otherwise
10: The MBSFN subframe allocations of all neighbour cells are
identical to or subsets of that in the serving cell on this
frequency, if configured, and of that in the PCell otherwise
01: No MBSFN subframes are present in all neighbour cells
11: Different UL/DL allocation in neighbouring cells for TDD
compared to the serving cell on this frequency, if configured,
and compared to the PCell otherwise For TDD, 00, 10 and 01 are
only used for same UL/DL allocation in neighbouring cells
compared to the serving cell on this frequency, if configured,
and compared to the PCell otherwise.

Similar to MBSFN subframes, TDD configuration (shown below) is taken into account when measuring neighbor cells. Only downlink and Downlink Pilot Time Slot (DwPTS) portions of special subframes contain symbols carrying CRS.

TABLE 1
Configuration of special subframe (lengths of
DwPTS/GP/UpPTS)

| | Normal cyclic prefix in | | | Extended cyclic prefix in | | |
|---|---|---|---|---|---|---|
| | downlink | | | downlink | | |
| | | UpPTS | | | UpPTS | |
| | | Normal | | | Normal | |
| | | cyclic | Extended | | cyclic | Extended |
| Special | | prefix | cyclic | | prefix | cyclic |
| subframe | | in | prefix | | in | prefix in |
| configuration | DwPTS | uplink | in uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | — | — | — |
| 8 | 24144 · Tₛ | | | — | — | — |

TABLE 2
Uplink-downlink configurations

| Uplink- | Downlink- | | | | | | | | | | |
|---|---|---|---|---|---|---|---|---|---|---|---|
| downlink | to-Uplink | | | | | | | | | | |
| Config- | Switch-point | Subframe number | | | | | | | | | |
| uration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

Special subframe configuration and uplink downlink configuration is indicated by specialSubframePatterns and subframeAssignment of TDD-Config, respectively in system information block type 1.

### TDD-Config

The IE TDD-Config is used to specify the TDD specific physical channel configuration.

| | |
|---|---|
| TDD-Config information element | |
| -- ASN1START | |
| TDD-Config ::= | SEQUENCE { |
| subframeAssignment | ENUMERATED { |
| | sa0, sa1, sa2, |
| sa3, sa4, sa5, sa6}, | |
| specialSubframePatterns | ENUMERATED { |
| | ssp0, ssp1, |
| ssp2, ssp3, ssp4,ssp5, ssp6, ssp7,ssp8} | |
| } | |
| TDD-Config-v11xy ::= | SEQUENCE { |
| specialSubframePatterns-v11xy | ENUMERATED |
| {ssp7,ssp9} | |
| } | |
| -- ASN1STOP | |

TDD-Config field descriptions

specialSubframePatterns
Indicates Configuration as in TS 36.211 [21, table 4.2-1] where ssp0
point to Configuration 0, ssp1 to Configuration 1 etc.
specialSubframePatterns-v11xy
Indicates special subframe patterns as in TS 36.211 [21, table 4.2-1].
The value ssp9 points to Configuration 9 for normal cyclic prefix and it
can only be present if the value of specialSubframePatterns is set to
ssp5. And the value ssp7 points to Configuration 7 for extended cyclic
prefix and it can only be present if the value of specialSubframePatterns
is set to ssp4. When this IE is present, values of specialSubframePatterns
in TDD-config (without suffix i.e. the version defined in REL-8) shall
be ignored.
subframeAssignment
Indicates DL/UL subframe configuration where sa0 point to Configuration
0, sa1 to Configuration 1 etc. as specified in TS 36.211 [21 , table 4.2-2].
One value applies for all serving cells residing on same frequency band

While the foregoing descriptions providing notification of E-UTRAN configuration while the mobile device 100 is camped in a E-UTRAN cell, such communication is not provided to the mobile device 100 while camped in a cell utilizing a RAT other than E-UTRA. Accordingly, methods and apparatus disclosed herein facilitate informing the mobile device 100 of the E-UTRA configuration.

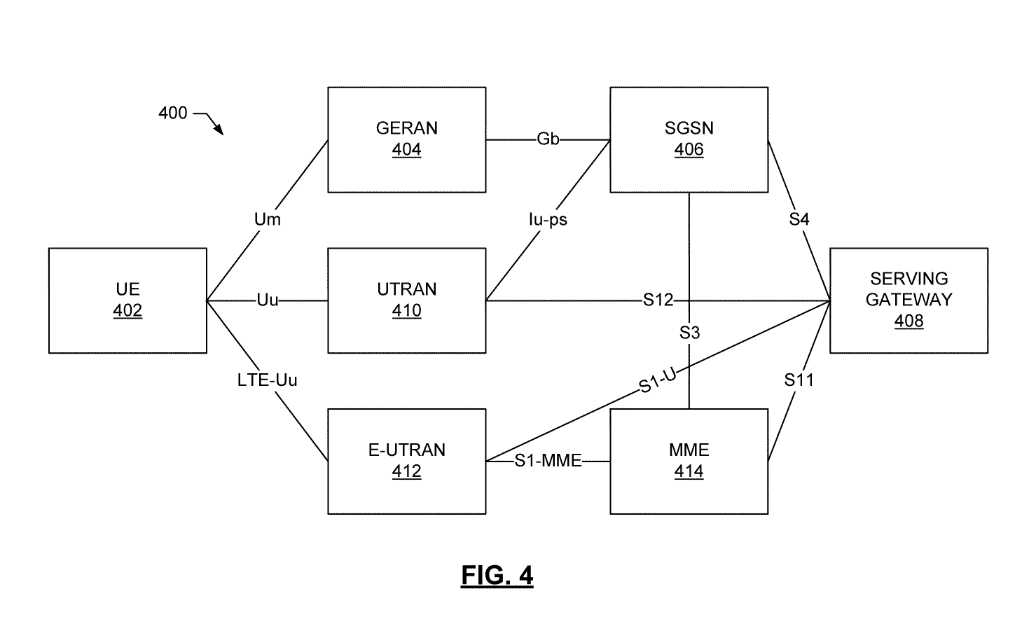

FIG. 4 is a block diagram of an example implementation of the network 400. The example network includes the RATs GERAN 404, UTRAN 410, and E-UTRAN 412. A user equipment (UE) 402, which may be the mobile device 100, is capable of communication with each of the GERAN 404, the UTRAN 410, and the E-UTRAN 412.

The GERAN 404 and the UTRAN 410 route packet data via a service general packet radio service (GPRS) support node (SGSN) 406. The E-UTRAN 412 routes packet data via a serving gateway 408 and communicates with the SGSN 406 via the mobile management entity 414. The SGSN 406, MME 414, and serving gateway 408 are well known in the art and, thus, are not described in further detail herein.

The GERAN 404, UTRAN 410, and E-UTRAN 412 are configured to facilitate informing the UE 402 of configuration information for the E-UTRAN while the UE 402 is camped on the GERAN 404 or the UTRAN 410.

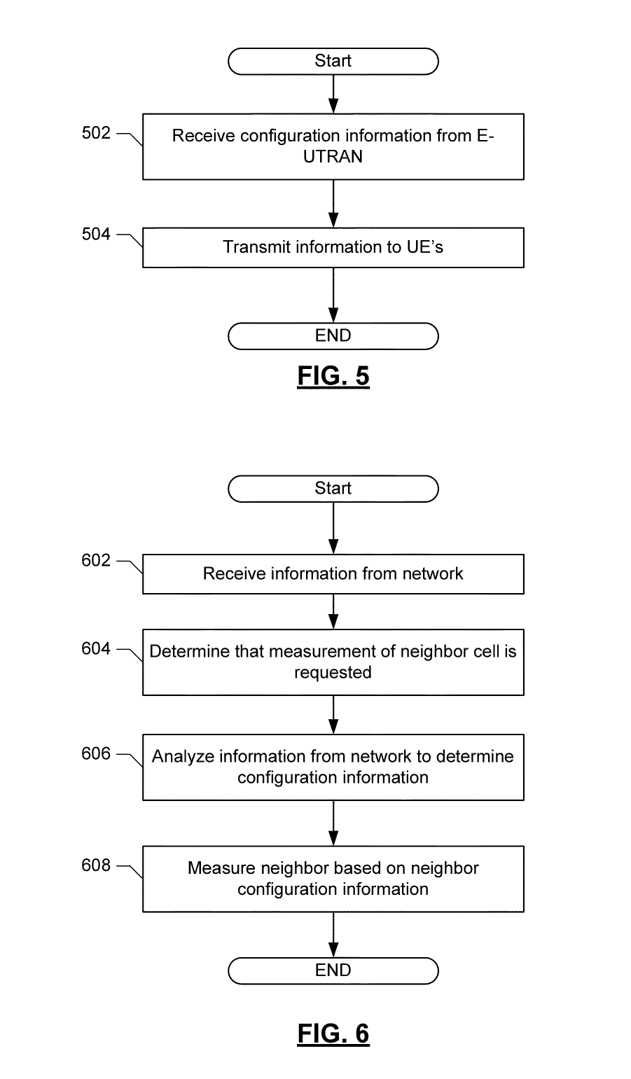

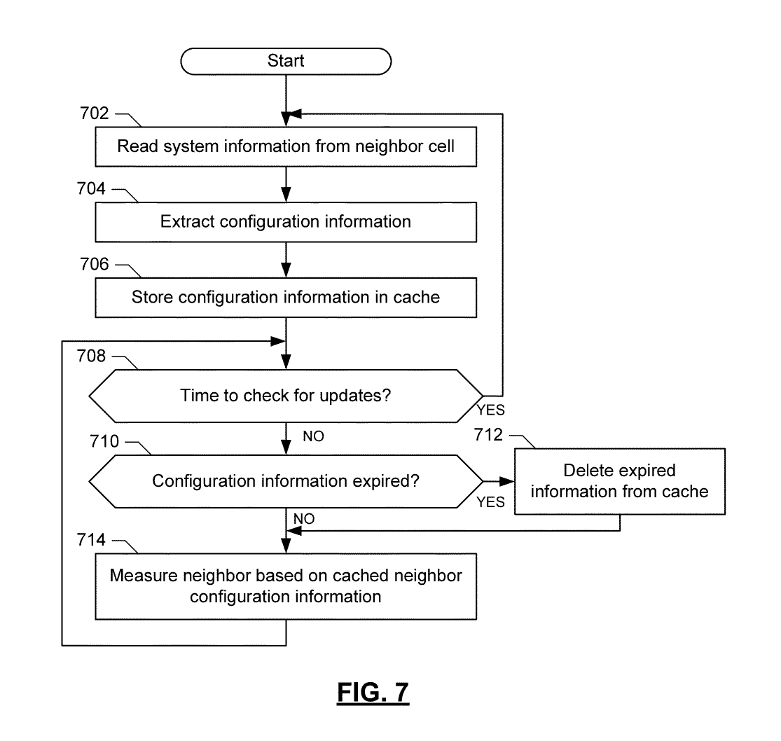

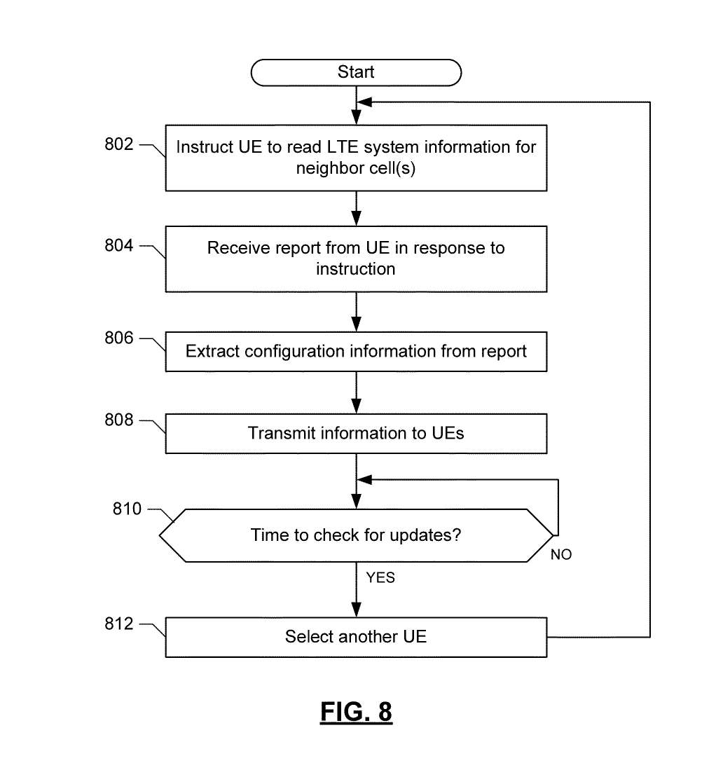

Flowcharts of example processes performed by the GERAN 404 and/or UTRAN 410 are shown in FIGS. 5 and 8. Flowcharts of example processes for implementing the configuration information handler 148 of FIG. 1 are shown in FIGS. 6 and 7. The example processes may be implemented by machine readable instructions comprising a program for execution by a processor such as the main processor 102 of FIG. 1. The machine readable instructions may be embodied in software stored on a computer readable medium such as a CD, a floppy disk, a hard drive, a DVD, Blu-ray disc, or a memory associated with the main processor 102, but the entire set of machine readable instructions and/or parts thereof could alternatively be executed by a device other than the main processor 102 and/or embodied in firmware or dedicated hardware. Further, although the example processes are described with reference to the flowcharts illustrated in FIGS. 5-8, many other methods of implementing the example configuration information handler 148 may alternatively be used. For example, the order of execution of the blocks may be changed, and/or some of the blocks described may be changed, eliminated, or combined.

As mentioned above, the example processes of FIGS. 5-8 may be implemented using coded instructions (e.g., computer readable instructions) stored on a tangible computer readable medium such as a hard disk drive, a flash memory, a ROM, a CD, a DVD, a Blu-ray disc, a cache, a RAM and/or any other storage media in which information is stored for any duration (e.g., for extended time periods, permanently, brief instances, for temporarily buffering, and/or for caching of the information). As used herein, the term tangible computer readable medium is expressly defined to include any type of computer readable storage and to exclude propagating signals.

FIG. 5 is a flowchart of example instructions performed by the GERAN 404 and/or the UTRAN 410. The example process begins when the GERAN 404 and/or the UTRAN 410 receives configuration information from the E-UTRAN 412 (block 502). Alternatively, GERAN 404 and/or the UTRAN 410 may request the configuration information from the E-UTRAN 412. The configuration information may include, for example, MBSFN allocation information (mbsfn-SubframeConfigList), Neighbour cell configuration information (NeighCellConfig) and/or TDD configuration information (tdd-Config). For example, the E-UTRAN 412 may transmit an information element comprising configuration information on an 51 or OAM interface to the GERAN 404 and/or the UTRAN 410. For example, EnodeB (eNB) Direct Information Transfer may be used to transfer radio access network (RAN) Information including the configuration information. The GERAN 404 and/or the UTRAN 410 may receive the configuration information from one or more neighbor E-UTRAN nodes to determine that MBSFN subframe configuration and/or TDD configuration is common for a sufficiently large area in GERAN or UTRAN per E-UTRA frequency. For example, more than 20 macro GERAN or UTRAN cells. The GERAN 404 and/or the UTRAN 410 may provide the configuration information to the UE when the above-condition is met.

The GERAN 404 and/or the UTRAN 410 transmits the configuration information per E-UTRA frequency received in block 502 (block 504). For example, a radio network controller (RNC) in, for example, the UTRAN 410, may include a MBSFN-SubframeConfigList in an E-UTRA frequency and priority information list carried in a system information block (e.g., system information block type 19), in an E-UTRA frequency list in a measurement control message, etc. The GERAN 404 may include an MBSFN-SubframeConfigList in an E-UTRAN Neighbor Cells information in a system information block (e.g., system information Type 2quater), in Measurement Information and Packet Measurement Information message, etc. For example, the GERAN 404 and/or the UTRAN 410 may determine that an MBSFN-SubframeConfigList received from the E-UTRAN 410 is common for all neighbor cells on a particular E-UTRAN frequency for an area of sufficiently large size. Additionally or alternatively, the RNC may include TDD configuration information (TDD-Config) if the corresponding E-UTRA frequency is for TDD in an E-UTRA frequency and priority information list carried in a system information block (e.g., system information block type 19), in an E-UTRA frequency list in a measurement control message, etc. The GERAN 404 may include a TDD-Config in an E-UTRAN Neighbor Cells information element in a system information block (e.g., system information Type 2quater), in Measurement Information and Packet Measurement Information message, etc.

An example E-UTRA frequency list transmitted by the UTRAN 410 to the mobile device 100 is shown in Table 3 below. The example E-UTRA frequency list includes MBSFN-SubframeConfig List and TDD-Config elements. Alternatively, only one of the MBSFN-SubframeConfigList and the TDD-Config elements may be included in a list.

TABLE 3
E-UTRA frequency list

| Information Element/ | | | Type and | Semantics | |
|---|---|---|---|---|---|
| Group name | Need | Multi | reference | description | Version |
| CHOICE E-UTRA frequency | MP | | | | REL-8 |
| removal | | | | | |
| >Remove all frequencies | | | | (no data) | REL-8 |
| >Remove some frequencies | | | | | REL-8 |
| >>Removed frequencies | MP | 1 to | | | REL-8 |
| | | <maxNumEUTRAFreqs> | | | |
| >>>E-UTRA frequencies | MP | | Integer | EARFCN of the | REL-8 |
| | | | (0 . . . 65535) | downlink carrier | |
| | | | | frequency [64] | |
| >Remove no frequencies | | | | (no data) | REL-8 |
| New frequencies | OP | 1 to | | | REL-8 |
| | | <maxNumEUTRAFreqs> | | | |
| >E-UTRA carrier frequency | MP | | Integer | EARFCN of the | REL-8 |
| | | | (0 . . . 65535) | downlink carrier | |
| | | | | frequency [64] | |
| >Measurement | MD | | Enumerated | Measurement | REL-8 |
| Bandwidth | | | (6, 15, 25, | bandwidth information | |
| | | | 50, 75, 100) | common for all | |
| | | | | neighbouring cells on | |
| | | | | the carrier frequency. It | |
| | | | | is defined by the | |
| | | | | parameter | |
| | | | | Transmission | |
| | | | | Bandwidth | |
| | | | | Configuration, N_{RB} | |
| | | | | [36.104]. The values | |
| | | | | indicate the number of | |
| | | | | resource blocks over | |
| | | | | which the UE could | |
| | | | | measure. Default value | |
| | | | | is 6. | |
| >Blacklisted cells | OP | 1 to | | A list of blacklisted cells | REL-8 |
| list | | <maxEUTRACellPerFreq> | | can be signalled per | |
| | | | | frequency | |
| >>Physical Cell | MP | | Integer | | REL-8 |
| identity | | | (0 . . . 503) | | |
| > MBSFN-SubframeConfigList | OP | | | MBSFN subframe | REL-11 |
| | | | | allocation information, | |
| | | | | as contained in E- | |
| | | | | UTRAN SIB2 | |
| > TDD-Config | OP | | | TDD Configuration | REL-11 |
| | | | | information as | |
| | | | | contained in E-UTRAN | |
| | | | | SIB1 | |
| E-UTRA SI | OP | | 10.3.7.127 | | REL-9 |
| Acquisition | | | | | |

Alternatively, the GERAN 404 and/or the UTRAN 410 may transmit the information to the mobile device 100 (block 504) utilizing a combined MBSFN subframe allocation. Transmitting the information utilizing a combined MBSFN subframe allocation avoids the mobile device 100 decoding PBCH to determine the SFN to apply the MBSFN-SubframeConfig List for RRM measurement of E-UTRAN neighbor cells. When MBSFN subframe allocation periodicity is larger than one radio frame, the mobile device 100 needs to know the SFN of an E-UTRAN cell to determine whether a current subframe is configured as an MBSFN subframe or not. In general, the mobile device 100 should not be required to read system information of another RAT. An example combined MBSFN subframe allocation indicates all the MBSFN subframes indicated in the MBSFN-SubframeConfigList within a single radio frame. For example, if subframe #6 and subframe #7 are assigned as MBSFN subframes in even radio frame and subframe #6 is assigned as an MBSFN subframe in odd radio frame, the combined allocation would be subframe #6 and subframe #7. The combined allocation may be repeated every radio frame so that the mobile device 100 does not have to know the SFN of the E-UTRA neighbor cell.

For example in FDD: The first/leftmost bit may define the allocation for subframe #1 of the radio frame indicated by mcch-RepetitionPeriod and mcch-Offset, the second bit for #2, the third bit for #3, the fourth bit for #6, the fifth bit for #7 and the sixth bit for #8. For example, in TDD: The first/leftmost bit may define the allocation for subframe #3 of the radio frame indicated by mcch-RepetitionPeriod and mcch-Offset, the second bit for #4, third bit for #7, fourth bit for #8, fifth bit for #9. Uplink subframes are not allocated. The last bit is not used.

Alternatively, a single bit may be indicated if MBSFN is used or not used. If the bit is indicated, the mobile device 100 may assume the all the subframes except the non-MBSFN subframes are assigned as MBSFN subframes during the measurement of E-UTRA neighbor cells. If the bit is not indicated, the mobile device 100 may assume none of the subframes are MBSFN subframes. Alternatively the bit, when present, may indicate that MBSFN is used. In such an example, legacy networks that do not support MBSFN will not transmit the bit and mobile devices will not assume that MBSFN is utilized when no bit is present.

FIG. 6 is a flowchart of example instructions performed by the configuration information handler 148 of the mobile device 100 while the mobile device 100 is camped on or connected to GERAN 404 or the UTRAN 410. The example process begins when the configuration information handler 148 receives E-UTRA information from the GERAN 404 or the UTRAN 410 (block 602). The configuration information handler 148 then determines that measurement of E-UTRA neighbor cells or frequencies is requested (block 604). For example, the configuration information handler 148 may determine that measurement of an E-UTRA frequency is requested in response to receiving the information (e.g., system information or measurement information sent by the GERAN 404 and/or the UTRAN 410.

The configuration information handler 148 then analyzes the received information to determine configuration information for E-UTRA neighbor frequencies or cells (block 606) for RRM measurement. According to the illustrated example, the example E-UTRA information includes at least one of MBSFN allocation information and/or TDD configuration information for E-UTRA neighbor frequencies or cells. For example, the configuration information handler 148 may access a MBSFN-SubframeConfigList and/or a TDD-Config element included in the E-UTRA information.

The configuration information handler 148 then causes the mobile device 100 to perform a measurement of the E-UTRAN 412 based on the extracted configuration information (block 608). For example, the configuration information reveals which subframes may be configured for MBSFN and which are not configured for MBSFN and can, thus, utilize all the symbols carrying CRS in the subframes not allocated for MBSFN and/or MBSFN subframes for performing measurements.

FIG. 7 is a flowchart of example instructions performed by the configuration information handler 148 of the mobile device 100 while the mobile device 100 is camped on GERAN 404 and/or the UTRAN 410. The example process of FIG. 7 begins when the configuration information handler 148 reads system information from an E-UTRA neighbor cell (block 702). The configuration information handler 148 extracts the configuration information from the system information (e.g MBSFN allocation information (mbsfn-SubframeConfigList), Neighbour cell configuration information (NeighCellConfig) and TDD configuration information (tdd-Config). The configuration information handler 148 then stores the configuration information in a cache (block 706). The stored information is utilized for measurement of each E-UTRA frequency by the mobile device 100 as described in paragraph 0059. After some time has passed, the configuration information handler 148 determines if it is time to check for updates (block 708). For example, the configuration information handler 148 may check for updates to the configuration every 10 minutes, every 30 minutes, based on a mobility state of the mobile device 100, etc. The mobile device 100 may learn how often the configuration information changes and adjust the timer according to the learned frequency of changes. The mobile device 100 may delete the configuration when the mobile device 100 moves more than a pre-determined distance (e.g. number of cells or routing area). When it is time to check for updates, control returns to block 702 to read the system information again.

When it is not time to check for updates (block 708), the configuration information handler 148 determines if any of the configuration information in the cache has expired (block 710). For example, configuration information may expire when it is not updated after a period of time (e.g., 30 minutes). When configuration information has expired, the configuration information handler 148 deletes the expired information from the cache (block 712)

When the configuration information in the cache is not expired (block 710) and has not been deleted in block 712, the configuration information handler 148 measures E-UTRA neighbor cells based on the cached neighbor configuration information (block 714). For example, block 714 may be performed at any time that a measurement is desired and information in the cache may be utilized whenever it is available. Accordingly, by caching the configuration information, the configuration information handler 148 may take advantage of the semi-static nature of MBSFN allocations.

FIG. 8 is a flowchart of example instructions performed by the GERAN 404 and/or the UTRAN 410. The example process begins when the GERAN 404 and/or the UTRAN 410 instructs a first mobile device 100 to read system information for neighbor cells (block 802). For example, the GERAN 404 and/or the UTRAN 410 may send a E-UTRA System Information Acquisition message as shown in Table 4. Alternatively, separate IEs could be used to request MBSFN and TDD information.

TABLE 4
E-UTRA SI Acquisition

| Information | | | Type and | Semantics | |
|---|---|---|---|---|---|
| Element/ | | | refer- | descrip- | Ver- |
| Group name | Need | Multi | ence | tion | sion |
| E-UTRA | MP | | Integer | EARFCN of | REL-9 |
| carrier | | | (0 . . . 65535) | the downlink | |
| frequency | | | | carrier | |
| | | | | frequency | |
| | | | | [64] | |
| Physical | MP | | Integer | | REL-9 |
| Cell | | | (0 . . . 503) | | |
| identity | | | | | |
| Request For | OP | | Boolean | If true | REL-11 |
| MBSFN/ | | | | MBSFB/TDD | |
| TDD Info | | | | information of | |
| | | | | the target cell | |
| | | | | and frequency | |
| | | | | is requested | |

In response to the request from the GERAN 404 and/or the UTRAN 410, the first mobile device 100 reads information from the E-UTRA neighbor cell(s) and transmits the information to the GERAN 404 and/or the UTRAN 410 (e.g., using RRC Measurement Report message in UMTS). Accordingly, the GERAN 404 and/or the UTRAN 410 receives the report from the mobile station 100 (block 804). The GERAN 404 and/or the UTRAN 410 extracts the configuration information from the report sent by the first mobile station 100 (block 806) and transmits the configuration information to a second mobile device 100 (or several other mobile devices) (block 808) The GERAN 404 and/or the UTRAN 410 may request the configuration information from one or more mobile devices 100 to determine that MBSFN subframe configuration and/or TDD configuration is common for a sufficiently large area in GERAN or UTRAN per E-UTRA frequency (e.g., more than 20 macro GERAN or UTRAN cells). The GERAN 404 and/or the UTRAN 410 may provide the configuration information to the UEs when the above-condition is met. The GERAN 404 and/or the UTRAN 410 then determines if it is time to check for updates to the configuration information (block 810). If it is not time to check for updates, the GERAN 404 and/or the UTRAN 410 continues waiting until it is time to check for updates. If it is time to check for updates, the GERAN 404 and/or the UTRAN 410 selects another mobile device 100 (e.g., a mobile device 100 different than the first mobile device 100) (block 812) and control returns to block 802 to instruct the newly selected mobile device 100. By selecting different mobile devices 100 each time an update is performed, the GERAN 404 and/or the UTRAN 410 can reduce the amount of resource utilization of any given mobile device 100.

The GERAN 404 and/or the UTRAN 410 may optimize selection of mobile devices 100 for gathering E-UTRA information. For example, because reading multiple SIBs (SIB1, 2 and 3) in an E-UTRA frequency may take more time and may be more disruptive to on-going communication with a serving cell (e.g. in UTRAN frequency) than just reading SIB1 (e.g. reading and reporting global cell identity), the GERAN 404 and/or the UTRAN 410 may select a mobile station 100 that can perform the task without configuring measurement gap based on the measurement capability of the mobile station 100. For example, to obtain the configuration information for a specific E-UTRA frequency in a first band, the network may select a mobile device 100 that does not require a measurement gap or compressed mode to measure the first band while the mobile station 100 is engaging communication with the GERAN 404 and/or the UTRAN 410 in a second band.

Alternatively, the GERAN 404 and/or the UTRAN may instruct the mobile device 100 to read and report only one of TDD-Config in SIB1, MbsfnSubframeConfig in SIB2 and NeighbourCellConfig in SIB3 to minimize the possible disruption to the on-going communication of a mobile device 100. The GERAN 404 and/or the UTRAN may obtain the complete configuration information by instructing multiple mobile devices 100 to report the various information elements.

While the foregoing describes a network instructing the mobile device 100 to obtain MBSFN configuration information and/or TDD configuration information, the network may instruct the mobile device 100 to retrieve any other type of information for reporting to the network. For example, the GERAN 404, the UTRAN 410, and/or the E-UTRAN 412 may instruct the mobile device 100 to retrieve, read, measure, etc. information about any of the GERAN 404, the UTRAN 410, and/or the E-UTRAN 412 and report the information to the network.

While the foregoing describes an example block diagram implementations and processes for implementing the mobile device 100, the GERAN 404, the UTRAN 410, and the E-UTRAN 412 other implementations are possible. For example, additional blocks may be included and additional or different connections between the blocks may exist.

While the foregoing makes reference to GERAN and UTRAN and RATs other than E-UTRAN, the RATs other than E-UTRAN may include any other RATs such as CDMA2000 or any other RATS.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

1. A method in a network device, the method comprising:
receiving configuration information including at least one of multimedia broadcast single frequency network (MBSFN) configuration or time division duplex (TDD) configuration for an evolved universal terrestrial radio access network (E-UTRAN); and
transmitting the configuration information to a user equipment, wherein the network device is associated with a radio access technology different from E-UTRAN.

2. A method as defined in claim 1, wherein the MBSFN configuration includes at least one of a MBSFN subframe allocation list or neighbor cell configuration information.

3. A method as defined in claim 1, wherein the network device receives the configuration information in a message sent by the E-UTRAN.

4. A method as defined in claim 3, wherein the message is sent using Si signaling.

5. A method as defined in claim 1, wherein the configuration information includes at least one of a MBSFN subframe configuration list or a TDD configuration and the configuration information is transmitted to the user equipment in information elements including at least one of an E-UTRA frequency and priority information list, an E-UTRA frequency list, or E-UTRA Neighbor Cells.

6. A method as defined in claim 1, wherein transmitting the configuration information comprises transmitting combined MBSFN allocation information indicated in a bit stream.

7. A method as defined in claim 1, wherein the network device receives the configuration information from at least one of the user equipment or a second user equipment.

8. A method as defined in claim 7, further comprising instructing a second user equipment to read the configuration information from a system information block of the E-UTRAN and to report the configuration information to the network device.

9. A method as defined in claim 8, wherein the instructing comprises instructing the second user equipment to read at least one of system information block 2 or system information block 3 when the configuration information is the MBSFN configuration and instructing at least one of the second user equipment or a third user equipment to read system information block 1 when the configuration information is the TDD configuration.

10. A method as defined in claim 8, further comprising selecting the second user equipment from among multiple user equipment communicating with the network device, wherein selecting the second user equipment comprises analyzing measurement capabilities of the second user equipment.

11. A method as defined in claim 10, wherein analyzing the measurement capabilities of the second user equipment comprises determining that the second user equipment is capable of reading the system information block without utilizing at least one of a measurement gap or a compressed mode.

12. A method as defined in claim 1, wherein the at least one of the MBSFN configuration or the TDD configuration are for a neighbor frequency of the E-UTRAN.

13. A network device comprising a processor configured to:
receive configuration information including at least one of multimedia broadcast single frequency network (MBSFN) configuration or time division duplex (TDD) configuration for an evolved universal terrestrial radio access network (E-UTRAN); and
transmit the configuration information to a user equipment, wherein the network device is associated with a radio access technology different from E-UTRAN.

14-34. (canceled)

35. A method in a user equipment camped on or connected to a radio access technology different from an evolved universal terrestrial radio access network (E-UTRAN), the method comprising:
receiving a system information block from a E-UTRAN, the system information block including configuration information for at least one of multimedia broadcast single frequency network (MBSFN) configuration or time division duplex (TDD) configuration;
storing the configuration information in a cache; and
measuring neighbor E-UTRAN cells based on the configuration information stored in the cache.

36. A method as defined in claim 35, wherein the user equipment receives the system information block via radio access technology different from E-UTRAN.

37. A method as defined in claim 35, wherein the user equipment receives the system information block via E-UTRAN radio access technology.

38. A method as defined in claim 35, wherein the configuration information is associated with neighbor E-UTRAN cells in a frequency to measure.

39. A method as defined in claim 35, further comprising repeating the receiving after a period of time.

40. A method as defined in claim 39, wherein the period of time is determined based on a mobility state of the user equipment.

41. A method as defined in claim 39, wherein the period of time is determined based on a multicast control channel (MCCH) modification period.

42. A user equipment camped on or connected to a radio access technology different from an evolved universal terrestrial radio access network (E-UTRAN), the user equipment comprising a processor configured to:
receive a system information block from a E-UTRAN, the system information block including configuration information for at least one of multimedia broadcast single frequency network (MBSFN) configuration or time division duplex (TDD) configuration;
store the configuration information in a cache; and
measure neighbor E-UTRAN cells based on the configuration information stored in the cache.

43-88. (canceled)
